(19) United States
(12) Patent Application Publication
(10) Pub. No.: US 2014/0095367 A1
(43) Pub. Date: Apr. 3, 2014

(54) SYSTEM AND METHOD FOR PROTECTING AGAINST CORPORATE CRISES

(71) Applicant: WILLIS LIMITED, London (GB)

(72) Inventors: Phillip ELLIS, London (GB); Eamonn McMURROUGH, London (GB); Chris GINGELL, London (GB)

(73) Assignee: Willis Limited, London (GB)

(21) Appl. No.: 13/632,735

(22) Filed: Oct. 1, 2012

(51) Int. Cl. G06Q 40/00; G06Q 40/04

(52) U.S. Cl. 705/37; 705/39

(57) ABSTRACT

A method, a system and a computer program are disclosed, which provide for a novel crisis management program. The method, system and computer program of the instant disclosure provide significant new protections to companies (buyers) against catastrophic events. A corporate buyer may enroll (or participate) in the crisis management program and reserve, for a payment, a fund infusion in the event of a significant crisis hitting a company, which may happen in a way that makes access to capital markets very expensive or not available at all. The method, system and computer program provide significant cash when it may be needed most by a company in crisis.

### BACKGROUND OF THE DISCLOSURE

1. Field of the Disclosure

This disclosure is directed to a method, a system, and a computer program for providing protection against catastrophic reversals in corporate performance.

2. Related Art

Corporate catastrophes are not rare. Even the world's most prestigious and largest companies frequently suffer disastrous reversals in their performance relative to the broad market about every seven years on average. During these events, liquidity often dries up, exacerbating the crisis. At these times, a company's reputation, management, and employees are under threat.

The present disclosure provides a novel method, a novel system and a novel computer program that may provide timely and adequate funds to relieve an entity that is undergoing a catastrophic event at a time when the cost and/or availability of working capital is a problem.

### SUMMARY OF THE DISCLOSURE

According to an aspect of the disclosure, a method, a system and a computer program are disclosed, which provide for a novel crisis management program. The method, system and computer program of the instant disclosure provide significant new protections to companies (buyers) against catastrophic events. A corporate buyer may enroll (or participate) in the crisis management program and reserve, for a payment, a fund infusion in the event of a significant crisis hitting a company, which may happen in a way that makes access to capital markets very expensive or not available at all. The method, system and computer program provide significant cash when it may be needed most by a company in crisis (for example, $ 1 billion in annual limit per buyer) at an indicative price of, for example, 4% of the limit per year, depending on the coverage selected and a company's market capitalization and/or liquidity history. This provision of funds is made based on the unique definition of ‘corporate crisis’ as, for example, a fall in stock price (or other corporate performance metric) relative to an index, including but not limited to a broad market index such as the S&P 500. This establishes the uniqueness of the company's problem (i.e., its non-systematic and catastrophic nature of the fall in relative price). As such, unique relief is given for a unique risk—a risk that is not defined by a ‘peril’ or a ‘fortuitous event’ as is characteristic of traditional insurance products. The product therefore addresses a critical ‘board level’ risk—a catastrophic reversal of fortune—with a product from outside the traditional insurance paradigm, and it does so regardless of peril or of an identifiable fortuitous event. In addition, insurance products often pay claims when there is little or no accompanying impact on absolute or relative share price. So frequently there is no ‘corporate damage’ as such, and yet premiums are paid by the company for arguably unnecessary insurance. The method described here potentially eliminates the need for insurance; therefore premiums can be avoided. In addition, this product is designed so that a synthetic equivalent using existing exchange-traded market instruments (puts, calls, etc) should not be possible.

According to an aspect of the disclosure, a computer-implemented method is disclosed for providing protection to an entity against a catastrophic event. The computer-implemented method comprises: receiving an enrollment request, which includes entity data, from a prospective enrollee device; determining, by a computer, a relevant market index based on the received entity data; determining, by the computer, enrollment eligibility of an entity that is associated with entity data based on the received entity data; and when the entity is determined to qualify for enrollment, setting, by the computer, a single payment limit amount to be paid to the entity when a trigger event is determined.

The computer-implemented method may further comprise: setting, by the computer, an annual aggregate limit amount to be paid to the entity when the triggering event is determined; setting, by the computer, a waiting period for the entity; setting, by the computer, a trigger event parameter for the entity; determining, by the computer, an enrollment price or an exclusion for the entity; and/or determining, by the computer, an underperformance metric k based on the one or more trigger event parameters and the determined relevant market index.

The entity data may comprise: a name of a company; a total number of outstanding shares of stock in a company; a stock symbol of a company; a desired coverage amount; a desired enrollment term; a name of a contact person; a telephone number of a contact person; an email address of a contact person; or historical performance data for a company.

The trigger event may be determined based on a change in one or more trigger event parameters. The one or more trigger event parameters may comprise a cost of debt.

The one or more trigger event parameters may comprise a stock price for the entity.

The underperformance metric k may be determined according to the relationships:

$$k = K ( t , d )$$

$$K ( t , d ) = 1 - \frac{S ( t )}{S ( t - d )} / \frac{I ( t )}{I ( t - d )}$$

where I is the determined relevant market index, S is a stock price of the entity, t is a positive non-zero integer that denotes a day on which a stock exchange is open for trading, d is a positive non-zero integer that denotes a number of trading days, S(t) is the adjusted closing stock price on trading day t, I(t) is the value of the determined relative market index at the close of the trading day t, K(t, d) is the underperformance metric measured over d trading days prior to trading day t, ending on the trading day t.

According to a further aspect of the disclosure, a system is disclosed for providing protection to an entity against a catastrophic event, including crisis management. The system comprises: a network that is configured to convey an enrollment request, which includes entity data, from a prospective enrollee device; and a computer that is configured to receive the enrollment request, including the entity data, from the prospective enrollee device, wherein the computer is further configured to: determine a relevant market index based on the received entity data; determine enrollment eligibility of an entity that is associated with entity data based on the received entity data; and when the entity is determined to qualify for enrollment, set a single payment limit amount to be paid to the entity when a trigger event is determined.

The computer may be configured to: set an annual aggregate limit amount to be paid to the entity when the triggering event is determined; set a waiting period for the entity; set a trigger event parameter for the entity; determine an enrollment price or an exclusion for the entity; and/or determine an underperformance metric k based on a trigger event parameter and the determined relevant market index.

The trigger event may be determined based on a change in one or more trigger event parameters, which comprise a stock price for the entity.

The computer may be further configured to determine an underperformance metric according to the relationships:

$$k = K ( t , d )$$

$$K ( t , d ) = 1 - \frac{S ( t )}{S ( t - d )} / \frac{I ( t )}{I ( t - d )}$$

where I is the determined relevant market index, S is a stock price of the entity, t is a positive non-zero integer that denotes a day on which a stock exchange is open for trading, d is a positive non-zero integer that denotes a number of trading days, S(t) is the adjusted closing stock price on trading day t, I(t) is the value of the determined relative market index at the close of the trading day t, K(t, d) is the underperformance metric measured over d trading days prior to trading day t, ending on the trading day t.

According to a still further aspect of the disclosure, a non-transitory computer-readable medium is disclosed, which includes computer-executable instructions stored thereon for providing protection to an entity against a catastrophic event. The computer-readable medium comprises computer executable instructions stored thereon, wherein the computer-executable instructions, in response to execution by a computer, cause the computer to perform operations of a method for crisis management, the operations comprising: receiving an enrollment request, which includes entity data, from a prospective enrollee device; determining a relevant market index based on the received entity data; determining enrollment eligibility of an entity that is associated with entity data based on the received entity data; and when the entity is determined to qualify for enrollment, setting a single payment limit amount to be paid to the entity when a trigger event is determined.

The operations may further comprise: setting an annual aggregate limit amount to be paid to the entity when the triggering event is determined; setting a triggering event parameter to a stock price for the entity; and setting a waiting period for the entity.

The operations may further comprise: determining an underperformance metric k based on one or more trigger event parameters and the determined relevant market index; and/or determining an underperformance metric k according to the relationships:

$$k = K ( t , d )$$

$$K ( t , d ) = 1 - \frac{S ( t )}{S ( t - d )} / \frac{I ( t )}{I ( t - d )}$$

where I is the determined relevant market index, S is a stock price of the entity, t is a positive non-zero integer that denotes a day on which a stock exchange is open for trading, d is a positive non-zero integer that denotes a number of trading days, S(t) is the adjusted closing stock price on trading day t, I(t) is the value of the determined relative market index at the close of the trading day t, K(t, d) is the underperformance metric measured over d trading days prior to trading day t, ending on the trading day t.

Additional features, advantages, and embodiments of the disclosure may be set forth or apparent from consideration of the following detailed description and drawings. Moreover, it is to be understood that both the foregoing summary of the disclosure, the following detailed description and drawings are exemplary and intended to provide further explanation without limiting the scope of the disclosure.

### BRIEF DESCRIPTION OF THE EXHIBITS

The accompanying drawings, which are included to provide a further understanding of the disclosure, are incorporated in and constitute a part of this specification, illustrate embodiments of the disclosure and together with the detailed description serve to explain the principles of the disclosure. No attempt is made to show structural details of the disclosure in more detail than may be necessary for a fundamental understanding of the disclosure and the various ways in which it may be practiced. In the exhibits:

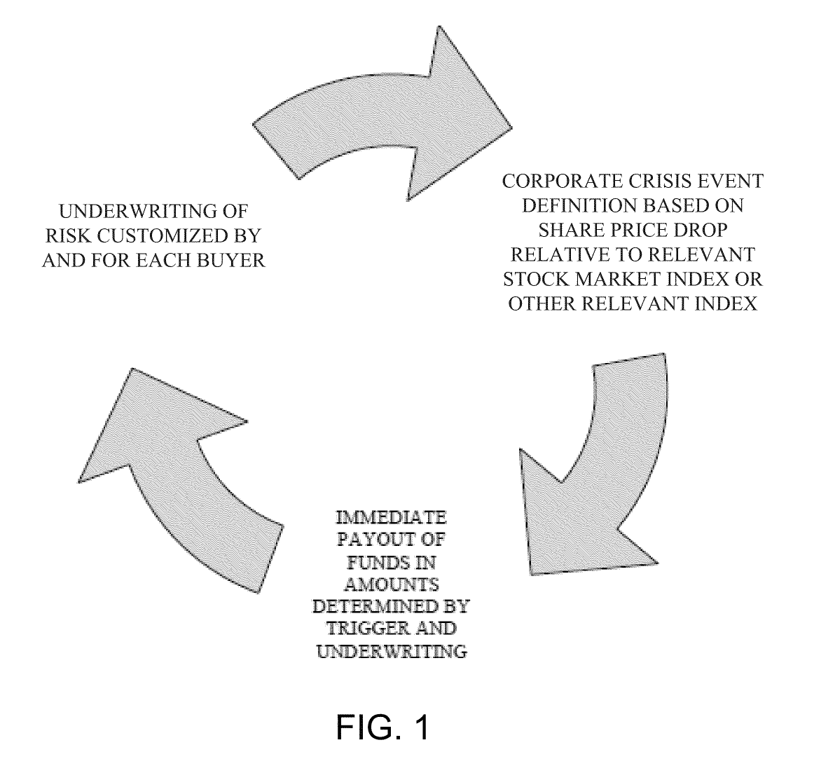

FIG. 1 shows a functional diagram for a crisis management program, according to the principles of the disclosure;

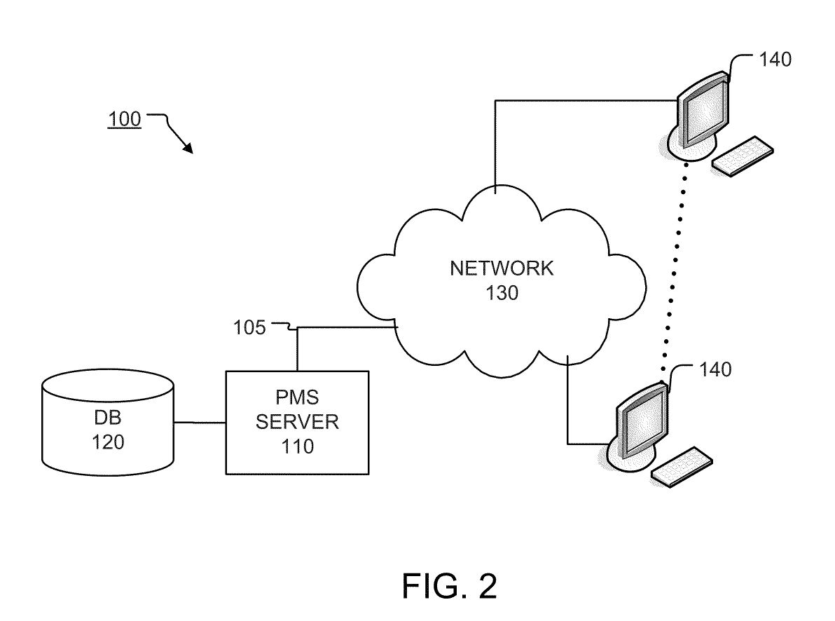

FIG. 2 shows an example of a performance management and payout system (PMPS), according to the principles of the disclosure;

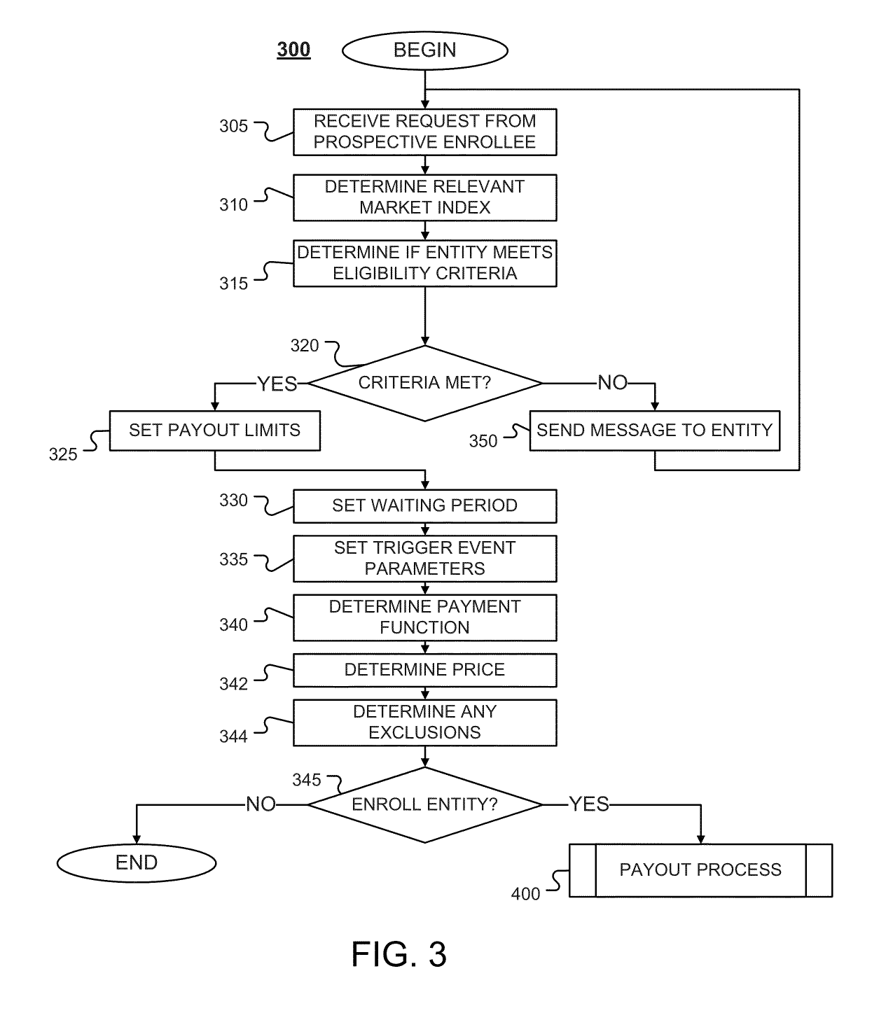

FIG. 3 shows an example of an enrollment process, according to the principles of the disclosure; and

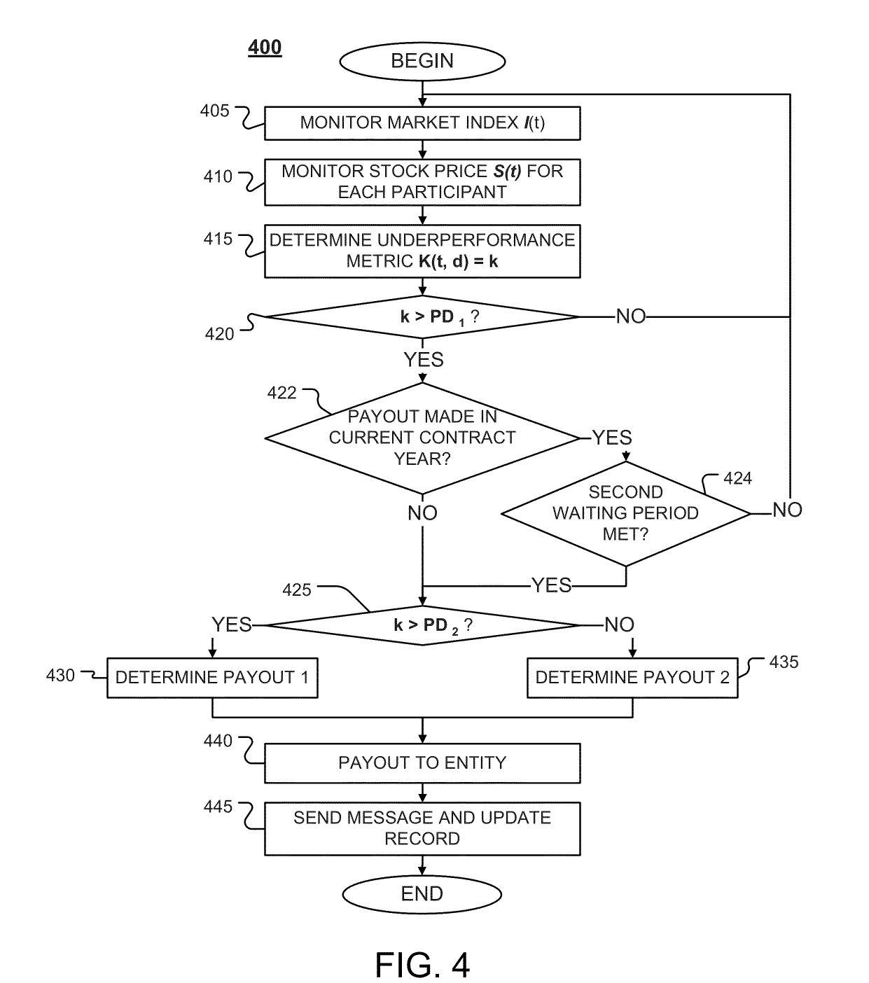

FIG. 4 shows an example of a payout process, according to the principles of the disclosure.

The present disclosure is further described in the detailed description that follows.

### DETAILED DESCRIPTION OF THE DISCLOSURE

The embodiments of the disclosure and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as one of ordinary skill in the art would recognize, even if not explicitly stated herein. Descriptions of well-known components and processing techniques may be omitted so as to not unnecessarily obscure the embodiments of the disclosure. The examples used herein are intended merely to facilitate an understanding of ways in which the disclosure may be practiced and to further enable those having skill in the art to practice the embodiments of the disclosure. Accordingly, the examples and embodiments herein should not be construed as limiting the scope of the disclosure, which is defined solely by the appended claims and applicable law. Moreover, it is noted that like reference numerals represent similar parts throughout the several views of the drawings.

A “computer”, as used in this disclosure, means any machine, device, circuit, component, or module, or any system of machines, devices, circuits, components, modules, or the like, which is (are) capable of manipulating data according to one or more instructions, such as, for example, without limitation, a processor, a microprocessor, a central processing unit, a general purpose computer, a super computer, a personal computer, a laptop computer, a palmtop computer, a notebook computer, a desktop computer, a workstation computer, a server, or the like, or an array of processors, microprocessors, central processing units, general purpose computers, super computers, personal computers, laptop computers, palmtop computers, notebook computers, desktop computers, workstation computers, servers, or the like. Further, the computer may include an electronic device configured to communicate over a communication link. The electronic device may include, for example, but is not limited to, a mobile telephone, a personal data assistant (PDA), a mobile computer, a stationary computer, a smart phone, mobile station, user equipment, or the like.

A “server”, as used in this disclosure, means any combination of software and/or hardware, including at least one application and/or at least one computer to perform services for connected clients as part of a client-server architecture. The at least one server application may include, but is not limited to, for example, an application program that can accept connections to service requests from clients by sending back responses to the clients. The server may be configured to run the at least one application, often under heavy workloads, unattended, for extended periods of time with minimal human direction. The server may include a plurality of computers configured, with the at least one application being divided among the computers depending upon the workload. For example, under light loading, the at least one application can run on a single computer. However, under heavy loading, multiple computers may be required to run the at least one application. The server, or any if its computers, may also be used as a workstation.

A “database”, as used in this disclosure, means any combination of software and/or hardware, including at least one application and/or at least one computer. The database may include a structured collection of records or data organized according to a database model, such as, for example, but not limited to at least one of a relational model, a hierarchical model, a network model or the like. The database may include a database management system application (DBMS) as is known in the art. The at least one application may include, but is not limited to, for example, an application program that can accept connections to service requests from clients by sending back responses to the clients. The database may be configured to run the at least one application, often under heavy workloads, unattended, for extended periods of time with minimal human direction.

A “network,” as used in this disclosure, means an arrangement of two or more communication links. A network may include, for example, the Internet, a local area network (LAN), a wide area network (WAN), a metropolitan area network (MAN), a personal area network (PAN), a campus area network, a corporate area network, a global area network (GAN), a broadband area network (BAN), any combination of the foregoing, or the like. The network may be configured to communicate data via a wireless and/or a wired communication medium. The network may include any one or more of the following topologies, including, for example, a point-to-point topology, a bus topology, a linear bus topology, a distributed bus topology, a star topology, an extended star topology, a distributed star topology, a ring topology, a mesh topology, a tree topology, or the like.

A “communication link” (or “communication links”), as used in this disclosure, means a wired and/or wireless medium that conveys data or information between at least two points. The wired or wireless medium may include, for example, a metallic conductor link, an air link, a fluid medium link, a radio frequency (RF) communication link, an Infrared (IR) communication link, an optical communication link, or the like, or any combination of the foregoing without limitation. The RF communication link may include, for example, WiFi, WiMAX, IEEE 802.11, DECT, 0G, 1G, 2G, 3G or 4G cellular standards, Bluetooth, or the like.

A “computer-readable medium”, as used in this disclosure, means any medium that participates in providing data (for example, instructions) which may be read by a computer. Such a medium may take many forms, including non-volatile media, volatile media, and transmission media. Non-volatile media may include, for example, optical or magnetic disks and other persistent memory. Volatile media may include dynamic random access memory (DRAM). Transmission media may include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer-readable media may be involved in carrying sequences of instructions to a computer, including, e.g., a non-transitory form of computer-readable medium. For example, sequences of instruction (i) may be delivered from a RAM to a processor, (ii) may be carried over a wireless transmission medium, and/or (iii) may be formatted according to numerous formats, standards or protocols, including, for example, WiFi, WiMAX, IEEE 802.11, DECT, 0G, 1G, 2G, 3G or 4G cellular standards, Bluetooth, or the like.

The terms “including”, “comprising” and variations thereof, as used in this disclosure, mean “including, but not limited to”, unless expressly specified otherwise.

The terms “a”, “an”, and “the”, as used in this disclosure, means “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

Although process steps, method steps, algorithms, or the like, may be described in a sequential order, such processes, methods and algorithms may be configured to work in alternate orders. In other words, any sequence or order of steps that may be described does not necessarily indicate a requirement that the steps be performed in that order. The steps of the processes, methods or algorithms described herein may be performed in any order practical. Further, some steps may be performed simultaneously.

When a single device or article is described herein, it will be readily apparent that more than one device or article may be used in place of a single device or article. Similarly, where more than one device or article is described herein, it will be readily apparent that a single device or article may be used in place of the more than one device or article. The functionality or the features of a device may be alternatively embodied by one or more other devices which are not explicitly described as having such functionality or features.

FIG. 1 shows a functional diagram for a crisis management program, according to the principles of the disclosure. According to an aspect of the disclosure, a corporate buyer may enroll (or participate) in the crisis management program and reserve, for a payment, a fund infusion in the event of a significant crisis hitting a company, which may happen in a way that makes access to capital markets very expensive or not available at all. Initially, as seen in FIG. 1, a significant fall in the stock price of the company may occur, where the fall in the stock price is measured relative to an appropriate market index, such as, for example, the S&P 500, the Dow Jones Industrial Average, NASDAQ, or the like. A trigger event may be set to a predetermined percentage drop (PD_{Set}) in the stock price of the company relative to the market index, such as, for example, 15%, 20%, or 25%, or any other agreed upon value. Since the trigger event is detected based on the percentage drop in the stock price of the company measured relative to the market index, the trigger event signifies a crisis that is particular to the buyer and is not systemic to the market. When the trigger event is detected, a substantially immediate payout of funds is provided to the company. The funds do not have to be repaid. The buyer's risk may be underwritten according to a predefined set of rules.

Prior to the presently disclosed method, system and computer program, little or no protection was available to entities (such as, for example, companies, corporations, and the like) to provide funds quickly to help recover from a catastrophic loss of market capitalization and an accompanying loss of liquidity. The method, system and computer program of the instant disclosure provide significant new protections to meet these needs, and do so in a way that improves the efficiency of financing risk. According to the disclosure, protection may be purchased at rates well below a buyer's cost of capital, and therefore can liberate debt or equity capital from the balance sheet so that it may be used to build the business of the company.

Demand is expected to be high for a crisis management program designed according to the principles of the instant disclosure, since a premium price may be significantly lower than a company's cost of capital. The annual claims may be limited to, for example, $500 million, $1 billion, or any other agreed upon payout, which is paid out promptly upon occurrence and determination of the trigger. A product according to the instant disclosure may afford a way to more fully optimize the risk management program for buyers.

In these ways, the instant disclosure is designed to provide an all-risk corporate catastrophe recovery protection plan to entities, such as, e.g., leading publicly-held (or privately held) companies. The protection may respond to sudden and severe corporate crises that may arise from a practically unlimited range of perils that result in damage to the corporate market capitalization and/or liquidity.

Research demonstrates that stock declines of, e.g., 20% or greater versus the S&P 500 Index within a twenty trading-day period happen to leading corporations on average more than once a decade, based on data from the last twenty years. Causes of such reversals are wide-ranging, but the contributors include, for example, sudden technology obsolescence (e.g., mainframes in early 1990s), product recalls (e.g., medication recalls in 2004), health scares (e.g., mad-cow disease crisis of 2000), loss of business due to terrorism fears (e.g., theme parks post-Sep. 11, 2001), and the like. The cost of responding in a way that corrects root causes can be very high, and the risk to an entity's management of not appearing to be prepared for and on top of the issues may be considerable.

Some companies explicitly maintain a monetary cushion on their balance sheets or have dedicated lines of credit to protect themselves in the event of such catastrophes. However, these forms of protection can be very expensive relative to the contingent capital available through the present disclosure. Financial reserves sitting on the balance sheet are not being used to invest in a company's business, and contingent debt burdens borrowing capacity. For example, a company that expects investment in its core business to yield 10% returns is forgoing those returns when it demands that its balance sheet acts as protection against corporate catastrophes. If cash is sitting on the balance sheet and earning, e.g., about 2%, the company may be losing, e.g., about 8% per year on this cash buffer.

The method and system according to the present disclosure are likely to reduce or eliminate premiums on some of a buyer's insurance programs by providing catastrophic risk cover for an effectively unlimited range of perils. Clearly, unlike repayments on lines of credit or loans or replenishment of cash on a balance sheet, claims payments according to the disclosed method or system do not have to be repaid. However, in the vent the buyer is, e.g., a captive insurance company, the parent may elect to replenish the capital of the captive which may have been depleted due to payment of an insurance claim to the parent under, e.g., a policy with a trigger. The method and system provide significant cash (e.g., $1 billion in annual limit per buyer, or the like) at an indicative price of, for example, 4% of the limit per year, depending on the cover selected liquidity history or other underwriting factors. To enable buyers to make claims, the method and system monitor stock performance and the appropriate indexes and communicate to a buyer when the trigger event is detected with regard to the particular buyer.

The premium rates available to a prospective buyer may be determined by evaluating the buyer's history of losses under the desired cover during the last twenty years. An adjustment may be made to reflect any trends in volatilities of the buyer's stock values and short-term interest rates relative to broader market volatility during a set period of time (e.g., 12 months, 24 months, 36 months, or the like); with increasing relative volatility incurring a higher premium, and lower relative volatility a lower premium.

The method and system of the present disclosure allow investors and buyers to gauge commerciality under a wide range of different assumptions and scenarios. Buyers may be able to customize their protection to meet their risk management needs and price preferences. The method and system may also allow managers and investors to make underwriting decisions based on overall risk profiles and the expected performance of portfolios as affected by the next buyer's preferences.

FIG. 2 shows an example of a performance management and payout system (PMPS) 100, which is configured according to the principles of the disclosure. The PMPS system 100 comprises a PMPS server 110, a database 120, a network 130, and a plurality of user devices 140, all of which may be interconnected via communication links 105. The PMPS server 110 may be linked to the plurality of user devices 140 through the network 130 and a plurality of the communication links 105. The PMPS server 110 may also be linked to the database 120 directly through a communication link 105, or indirectly (not shown) through a communication link 105 and the network 130. The PMPS server 110 may be provided with a computer readable medium (not shown) that embodies a computer program, which, when executed by the PMPS server 110, carries out a crisis management program, which may include an enrollment process 300 and/or a payout process 400, shown in FIGS. 3 and 4, respectively. The computer readable medium may comprise executable instructions, including a code segment or code section associated with and carrying out each of the steps of the enrollment process 300 (shown in FIG. 3) and the payout process 400 (shown in FIG. 4).

FIG. 3 shows an example of the enrollment process 300, according to principles of the disclosure. Referring to FIGS. 1 and 3 concurrently, an enrollment (or buyer) request may be received by the PMPS server 110 from a user device 140 of a prospective enrollee (“buyer”) who wishes to enroll a particular entity (e.g., company, corporation, or the like) in the crisis management program (Step 305). The enrollment request may include entity data. The entity data may include company information, such as, for example, a name of the company, a total number of outstanding shares of stock in the company, a stock symbol, a desired coverage amount, a desired enrollment term, a name of a contact person, a telephone number of the contact person, an email address of the contact person, historical performance information for the company, and the like.

On the basis of the entity data, the PMPS server 110 may determine the relevant markets and one or more market indices I that may be relevant to measuring the entity's performance (Step 310). Also based on the entity data, the PMPS server 110 may determine whether the entity may be eligible for participation in the crisis management program (Step 315). The enrollment determination may be based on one or more entity qualification criteria, such as, for example, historical performance data for the company stock, the year when the company was incorporated, where the company is incorporated, the number of employees, a debt to income ratio, and the like.

If the entity is determined to meet the entity qualification criteria (YES at Step 320), then a single payment limit amount and an annual aggregate limit amount may be determined and set (Step 325). If the entity, however, does not meet the entity qualification criteria (NO at Step 320), then a message may be sent to the user device 140 (Step 350) and the process may return to receive another enrollment request (Step 305). The message may include, for example, a notice that the entity does not qualify for enrollment in the crisis management program because the entity fails to meet one or more entity qualification criteria.

The single payment limit amount may be set to, for example, the smaller of 1% of the market capital value of the entity or $1 billion (i.e., Min{1% of Market Cap., $1bn}). Other values for the percentage of the market capital value of the entity or the fixed dollar amount may be equally used for the single payment limit (i.e., Min{a % of Market Cap., $b bn}, where a is a real, positive number between 0 and 100 and b is a real, positive number). The annual aggregate limit may be set to, for example, the smaller of 2% of the market capital value of the entity or $2 billion (i.e., Min{2% of Market Cap., $2bn}) during a one-year period. Other values for the percentage of the market capital value of the entity or the fixed dollar amount may be equally used for the annual aggregate limit during a one-year period (i.e., Min {c % of Market Cap., $e bn}, where c is a real, positive number between 0 and 100 and e is a real, positive, non-zero currency number). The market capital value may be measured at the time of inception or at the time of the most recent anniversary.

A waiting period may be set for the newly enrolling entity (Step 330). The waiting period may be set to, for example, the first sixty trading days from enrollment (e.g., contract inception), or within, for example, sixty trading days following a payment.

A trigger event may be determined and set for the particular entity, including one or more trigger event parameters (Step 335). The trigger event parameters may include, for example, a stock value (or price) of the entity (e.g., company stock), a cost of debt, and the like. The trigger event may be determined by monitoring changes over time in the one or more trigger event parameters, including, for example, a change in value of the stock of the entity (e.g., company stock) over a predetermined period of time compared to the predetermined percentage drop PD_{Set} value, as measured relative to the market index I, the rate at which change in the entity stock value occurred (e.g., the number of days), an increase in cost of debt, and the like. The monitored changes in the one or more trigger event parameters may be verified for accuracy.

On the basis of the entity data, a payout amount(s) and a payment function may be determined for the particular entity (Step 340). The payout amount may be set to a single payout amount (e.g., $1 billion), which may be paid out to an enrolled entity as a single (or multiple) electronic deposit to, e.g., the enrolled entity's bank account after the trigger event has been detected and determined. The payment function is a factor in determining prices.

The payout amount may be paid out to an enrolled entity after the change in value of the entity's stock exceeds the predetermined percentage drop PD_{Set} value, as measured relative to the market index I, and the trigger event occurs after the waiting period and all payment dues are current. Alternatively, multiple payout amounts may be determined for the particular entity, which may be determined on the basis of different trigger events (Step 340). For example, two or more payout amounts may be determined for varying degrees in the change in value of the entity's stock relative to the predetermined percentage drop PD_{Set} value, as is discussed below with reference to FIG. 4.

An enrollment price may be determined for the entity's enrollment in the program based on, for example, the entity data, the relevant market(s), historical data relating to the entity, historical data relating to relevant market(s), and the like (Step 342). Further, one or more exclusions may be determined for the entity (Step 344). The one or more exclusions may include, for example, fraud by top management or Board members of the buyer which contribute to the triggering event, a fall in share price due to a merger or acquisition, or the like.

The prospective enrollee entity may elect to enroll in the crisis management program (YES at Step 345), in which case the payout process 400 may be initiated, otherwise the process 300 may end (NO at Step 345).

FIG. 4 shows an example of a payout process 400, according to the principles of the disclosure. After an entity enrolls in the crisis management program (enrollment process 300, shown in FIG. 3), the relevant market index (or indices) I may be monitored as a function of time (Step 405). Additionally, the stock price S of the enrolled entity, as well as all other participants in the crisis management program, may be monitored as a function of time (Step 410). The stock price S and relevant market index I may be measured continuously or at periodic intervals (such as, for example, at the closing of each trading day). An underperformance metric K(t, t_{d}) (or k) may be determined based on the measured stock price S and the market index I according to the following relationships (Step 415).

$$K ( t , d ) = 1 - \frac{S ( t )}{S ( t - d )} / \frac{I ( t )}{I ( t - d )}$$

$$k = K ( t , d )$$

where t is a positive non-zero integer that denotes a day on which a stock exchange (for example, New York Stock Exchange) is open for trading; d is a positive non-zero integer that denotes a number of trading days; S(t) is the adjusted closing stock price on trading day t; I(t) is the value of the market index (for example, the S&P 500) at the close of the trading day t; and K(t, d) is the underperformance metric measured over d trading days prior to trading day t, ending on trading day t. Continuity adjustments may be made for share splits, rights issues, dividends, and the like.

The following requirements may be set for a payout to be made to the enrolled entity at the end of trading day t+d, including, for example: K(t, d) must be greater than PD_{Set}; t must be at least sixty trading days after enrollment (e.g., contract inception); there is no outstanding payment due; the Annual Aggregate Limit has not been met; and the like.

The underperformance metric k may have multiple measurement periods, such as, for example, K(t, d1, d2), where d1 and d2 are positive, non-zero integers. Further, multiple predetermined percentage drop values PD₁, PD₂, etc. (instead of a single PD_{Set} value) may be set, to provide for different stages and injection amounts of cash under the enrollment contract.

For example, d1 may be set to 10, d2 may be set to 20, PD₁ may be set to 20%, and PD₂ may be set to 50%. In this example, the crisis management program may be set to payout the following amounts based on value of k.

| Value of k | Payment as % of Single Payment Limit |
|---|---|
| k < 20% (PD₁) | Zero |
| 20% (PD₁) ≦ k < 50% (PD₂) | $20 \% + \frac{k - 20 \%}{50 \% - 20 \%} \times 80 \%$ |
| 50% ≦ k | 100% |

In FIG. 4, a determination may be made whether the underperformance metric k is greater than a predetermined percentage drop value PD₁ (Step 420). If a determination is made that the measured underperformance metric is greater than the value PD₁ (YES at Step 420), then a determination may be made whether a payout has been made to the entity in the current contract year (Step 422), otherwise the process continues to monitor the market index I (NO at Step 420, then Step 405).

If it is determined that a payout has not been made in the current contract year (NO at Step 422), then a determination may be made whether the measured underperformance metric is greater than the value PD₂ (Step 425), otherwise a determination may be made whether the second waiting period requirement has been met (YES at Step 422, then Step 424).

If it is determined that the second waiting period requirement has been met (YES at Step 424), then the determination may be made whether the measured underperformance metric is greater than the value PD₂ (YES at Step 424, then Step 425).

If a determination is made that the measured underperformance metric is greater than the value PD₂ (YES at Step 425), then a first payout amount may be determined (Step 430), otherwise a second payout amount may be determined (NO at Step 425, then Step 435).

In the above example, the enrollment contract may payout if, over ten trading days, the stock underperforms the index by at least 20%. The payout amount may depend on the relative performance of the stock over the subsequent ten trading days. The payout may be determined based on the cumulative underperformance of the stock over twenty trading days. If the cumulative underperformance over twenty days is less than 20% (which may imply some degree of recovery in the second ten day period), then no payout is due. If the cumulative underperformance is 20% or greater, then a payment of at least 20% of the Single Payment Limit payout is due, increasing to 100% of the Single Payment Limit if underperformance reaches 50%, all of which may be subject to not exceeding the overall Annual Aggregate Limit.

Where only a single value PD is set, Steps 425 and 435 may be eliminated. Alternatively, additional determinations and payouts may be added, depending on the number of PD values set, as one of ordinary skill in the art will recognize.

After the payout amount(s) has been determined, the payout may be, for example, deposited directly to an account belonging to the enrolled entity (Step 440). A message may be created and sent to the enrolled entity regarding the payout and a record associated with the enrolled entity may be updated in, for example, the database 120 (shown in FIG. 2).

Although the disclosure has been provided with reference to several embodiments, it is understood that the words that have been used are words of description and illustration, rather than words of limitation. Changes may be made within the purview of the appended claims, as presently stated and as amended, without departing from the scope and spirit of the disclosure in its aspects. Although the disclosure has been described with reference to particular means, materials and embodiments, the disclosure is not intended to be limited to the particulars disclosed; rather, the disclosure extends to all functionally equivalent structures, methods, and uses such as are within the scope of the appended claims.

In accordance with various embodiments of the present disclosure, the methods described herein are intended for operation as software programs running on a computer. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

Although the present specification describes components and functions implemented in the embodiments with reference to particular standards and protocols, the disclosure is not limited to such standards and protocols. Accordingly, replacement standards and protocols having the same functions are considered equivalent.

While the disclosure has been described in terms of exemplary embodiments, those skilled in the art will recognize that the disclosure can be practiced with modifications in the spirit and scope of the appended claims. These examples given above are merely illustrative and are not meant to be an exhaustive list of all possible designs, embodiments, applications or modifications of the disclosure.

What is claimed is:

1. A computer-implemented method, comprising:
receiving an enrollment request, which includes entity data, from a prospective enrollee device;
determining, by a computer, a relevant market index based on the received entity data;
determining, by the computer, enrollment eligibility of an entity that is associated with entity data based on the received entity data; and
when the entity is determined to qualify for enrollment, setting, by the computer, a single payment limit amount to be paid to the entity when a trigger event is determined.

2. The computer-implemented method of claim 1, further comprising:
setting, by the computer, an annual aggregate limit amount to be paid to the entity when the triggering event is determined.

3. The computer-implemented method of claim 1, wherein the entity data comprises:
a name of a company;
a total number of outstanding shares of stock in a company;
a stock symbol of a company;
a desired coverage amount;
a desired enrollment term;
a name of a contact person;
a telephone number of a contact person;
an email address of a contact person; or
historical performance data for a company.

4. The computer-implemented method of claim 1, wherein the trigger event is determined based on a change in one or more trigger event parameters.

5. The computer-implemented method of claim 4, wherein the one or more trigger event parameters comprise a stock price for the entity.

6. The computer-implemented method of claim 1, wherein the one or more trigger event parameters further comprise a cost of debt.

7. The computer-implemented method of claim 1, further comprising:
setting, by the computer, a waiting period for the entity.

8. The computer-implemented method of claim 1, further comprising:
setting, by the computer, a trigger event parameter for the entity.

9. The computer-implemented method of claim 1, further comprising:
determining, by the computer, an enrollment price or an exclusion for the entity.

10. The computer-implemented method of claim 4, further comprising:
determining, by the computer, an underperformance metric k based on the one or more trigger event parameters and the determined relevant market index.

11. The computer-implemented method of claim 10, wherein the underperformance metric k is determined according to the relationships:
$$k = K ( t , d )$$
$$K ( t , d ) = 1 - \frac{S ( t )}{S ( t - d )} / \frac{I ( t )}{I ( t - d )}$$
where I is the determined relevant market index, S is a stock price of the entity, t is a positive non-zero integer that denotes a day on which a stock exchange is open for trading, d is a positive non-zero integer that denotes a number of trading days, S(t) is the adjusted closing stock price on trading day t, I(t) is the value of the determined relative market index at the close of the trading day t, K(t, d) is the underperformance metric measured over d trading days prior to trading day t, ending on the trading day t.

12. A system for crisis management, the system comprising:
a network that is configured to convey an enrollment request, which includes entity data, from a prospective enrollee device; and
a computer that is configured to receive the enrollment request, including the entity data, from the prospective enrollee device, wherein the computer is further configured to:
determine a relevant market index based on the received entity data;
determine enrollment eligibility of an entity that is associated with entity data based on the received entity data; and
when the entity is determined to qualify for enrollment, set a single payment limit amount to be paid to the entity when a trigger event is determined.

13. The system of claim 12, wherein the computer is further configured to:
set an annual aggregate limit amount to be paid to the entity when the triggering event is determined.

14. The system of claim 12, wherein the trigger event is determined based on a change in one or more trigger event parameters, which comprise a stock price for the entity.

15. The system of claim 12, wherein the computer is further configured to:
set a waiting period for the entity;
set a trigger event parameter for the entity: or
determine an enrollment price or an exclusion for the entity.

16. The system of claim 12, wherein the computer is further configured to:
determine an underperformance metric k based on a trigger event parameter and the determined relevant market index.

17. The system of claim 12, wherein the computer is further configured to:
determine an underperformance metric according to the relationships:
$$k = K ( t , d )$$
$$K ( t , d ) = 1 - \frac{S ( t )}{S ( t - d )} / \frac{I ( t )}{I ( t - d )}$$
where I is the determined relevant market index, S is a stock price of the entity, t is a positive non-zero integer that denotes a day on which a stock exchange is open for trading, d is a positive non-zero integer that denotes a number of trading days, S(t) is the adjusted closing stock price on trading day t, I(t) is the value of the determined relative market index at the close of the trading day t, K(t, d) is the underperformance metric measured over d trading days prior to trading day t, ending on the trading day t.

18. A non-transitory computer-readable medium having computer executable instructions stored thereon, wherein the computer-executable instructions, in response to execution by a computer, cause the computer to perform operations of a method for crisis management, the operations comprising:
receiving an enrollment request, which includes entity data, from a prospective enrollee device;
determining a relevant market index based on the received entity data;
determining enrollment eligibility of an entity that is associated with entity data based on the received entity data; and
when the entity is determined to qualify for enrollment, setting a single payment limit amount to be paid to the entity when a trigger event is determined.

19. The non-transitory computer-readable medium of claim 18, wherein the operations further comprise:
setting an annual aggregate limit amount to be paid to the entity when the triggering event is determined;
setting a triggering event parameter to a stock price for the entity; and
setting a waiting period for the entity.

20. The non-transitory computer-readable medium of claim 18, wherein the operations further comprise:
determining an underperformance metric k based on one or more trigger event parameters and the determined relevant market index.

21. The non-transitory computer-readable medium of claim 18, wherein the operations further comprise:
determining an underperformance metric k according to the relationships:
$$k = K ( t , d )$$
$$K ( t , d ) = 1 - \frac{S ( t )}{S ( t - d )} / \frac{I ( t )}{I ( t - d )}$$
where I is the determined relevant market index, S is a stock price of the entity, t is a positive non-zero integer that denotes a day on which a stock exchange is open for trading, d is a positive non-zero integer that denotes a number of trading days, S(t) is the adjusted closing stock price on trading day t, I(t) is the value of the determined relative market index at the close of the trading day t, K(t, d) is the underperformance metric measured over d trading days prior to trading day t, ending on the trading day t.
